(19) United States
(12) Patent Application Publication
(10) Pub. No.: US 2013/0297183 A1
(43) Pub. Date: Nov. 7, 2013

(54) METHOD OF OPERATING AN INTERNAL COMBUSTION ENGINE WITH DIRECT FUEL INJECTION AND LOW NOx EMISSIONS

(71) Applicant: DAIMLER AG, Stuttgart (DE)

(72) Inventors: Torsten Dieler, Stuttgart (DE); Dirk Haase, Leutenbach (DE); Ruediger Herweg, Esslingen (DE)

(73) Assignee: DAIMLER AG, Stuttgart (DE)

(21) Appl. No.: 13/856,088

(22) Filed: Apr. 3, 2013

Related U.S. Application Data
(63) Continuation-in-part of application No. PCT/EP2011/004977, filed on Oct. 6, 2011.

(30) Foreign Application Priority Data
Oct. 7, 2010 (DE) 10 2010 047 798.2
Mar. 31, 2011 (DE) 10 2011 015 628.3

(51) Int. Cl. F02D 41/04

(52) U.S. Cl. CPC F02D 41/04
USPC 701/103

(57) ABSTRACT

In an operating method for an internal combustion engine with direct fuel injection including a plurality of combustion chambers, in particular a direct-injection gasoline engine for a motor vehicle, wherein the operating method comprises low-NOx combustion (NAV) and uses a plurality of partial operating modes, wherein, in a NAV partial operating mode, water is injected into the respective combustion chamber, and, during said NAV partial operating mode, at an ignition point (ZZP), a largely homogeneous, lean fuel/exhaust gas/air mixture having a combustion air ratio of λ≧1 is spark ignited by means of an ignition device so as to initiate flame front combustion (FFV) with a transition to a controlled auto-ignition (RZV). The injection of water permits the NAV partial operating mode to be stably implemented even at high engine loads and speeds.

This is a continuation-in-part application of pending international patent application PCT/EP2011/004977 filed Dec. 19, 2011 and claiming the priority of German patent applications 10 2010 047 798.2 filed 7 Oct. 2010 and 10 2011 015 628.3 filed 31 Mar. 2011.

The present invention relates to a method for operating an internal combustion engine, in particular a reciprocating piston engine such as a gasoline engine with direct fuel injection in a motor vehicle having low-NOₓ combustion (NAV).

Downsizing can be used in the automotive engineering sector, in addition to other measures, in order to reduce CO₂ emissions. In this context downsizing means constructing, employing and operating small-displacement engines in such a way that they achieve equivalent or better rankings with respect to driving behavior when compared to their predecessor large-displacement engines. Downsizing allows fuel consumption to be reduced and thus CO₂ emissions to be lowered. In addition, engines with smaller displacements have lower overall frictional losses.

Smaller displacement engines are, however, characterized by having lower torque, especially at low speeds, leading to the vehicle having a poorer dynamic response and thus reduced flexibility. Disadvantages associated with the downsizing of gasoline engines can be largely compensated for through appropriate operating methods.

From EP 1 543 228 B1 is, for example, an operating mode known wherein a lean fuel/exhaust gas/air mixture in the combustion chamber of the internal combustion engine is caused to auto-ignite. In order that compression ignition occurs at the desired time, fuel is injected into the lean, homogeneous fuel/exhaust gas/air mixture in the combustion chamber at the appropriate compression shortly before being spark ignited, so that a richer fuel-air mixture is formed. Embedded in the lean, homogeneous fuel/exhaust gas/air mixture, this concentrated fuel-air mixture serves as the initiator for compression-ignited combustion in the combustion chamber.

DE102006041467A1 contains a description for an operating mode for a gasoline engine with homogeneous, compression-ignited combustion. If the homogeneous fuel/exhaust gas/air mixture, said mixture being a lean mixture, is compressed, in contrast to the spark ignited, Otto-cycle operating mode, combustion does not spread in the combustion chamber as a flame front combustion originating from the point of ignition, but instead at an appropriate compression level, the homogeneous fuel/exhaust gas/air mixture ignites at several points in the respective combustion chamber almost simultaneously, so that in this case controlled auto-ignition sets in. Controlled auto-ignition (RZV) exhibits significantly lower nitrogen oxide emissions along with high efficiency in terms of fuel consumption compared to the spark-ignited, Otto-cycle operating mode. This low-emission, efficient RZV operating mode with controlled auto-ignition can, however, only be used at a lower and possibly medium engine load/engine speed range, as knocking tendency increases with decreasing charge dilution, and thus the useful application of the RZV operating mode in higher engine load ranges is limited.

DE102007047026A1 describes an operating mode of a gasoline engine. As part of the operating mode, combustion in the gasoline engine is initiated by compression ignition, and after self-ignition of the fuel/exhaust gas/air mixture has begun, water is injected into the combustion chamber.

Another operating mode for an internal combustion engine is known from U.S. Pat. No. 7,574,983B2, where the internal combustion engine can be run in a homogeneous charge compression ignition (HCCI) and/or spark ignition (SI) mode. By injecting water into the combustion chamber during the expansion stroke, the heat of combustion of the fuel/exhaust gas/air mixture can be to some extent reduced, and thus conditions that could result in unintentional combustion can be avoided.

Although the region of the engine characteristics map for the respective partial operating mode can be expanded by using water injection, the operating range of a pure RZV partial operating mode is nevertheless limited despite water injection.

It is therefore the principal object of the present invention to provide an improved method of operating in particular a directly fuel injected internal combustion engine having a plurality of combustion chambers in which a controlled auto-ignition can be implemented in a larger engine load range and/or engine speed range.

### SUMMARY OF THE INVENTION

In an operating method for an internal combustion engine, in particular a directly injected internal combustion engine with a plurality of combustion chambers, in particular for a direct-injection gasoline engine for a motor vehicle, wherein the operating method comprises low-NOx combustion (NAV) and uses a plurality of partial operating modes, wherein in a NAV partial operating mode water is injected into the respective combustion chamber, and, during said NAV partial operating mode, at an ignition point (ZZP), a largely homogeneous, lean fuel/exhaust gas/air mixture having a combustion air ratio of λ≧1 is spark ignited by means of an ignition device so as to initiate flame front combustion (FFV) with transitions to a controlled auto-ignition (RZV). The injection of water permits the NAV partial operating mode to be stably implemented even at high engine loads.

The injection of water into the combustion chamber results in an advantageous lower pressure rise and a decrease in knocking tendency. Furthermore, by using water injection it is also possible to implement the NAV partial operating mode at higher engine loads than compared to the NAV partial operating mode without water injection and due to the at least partially occurring controlled auto-ignition (RZV), a reduction in NOx emissions is possible.

In a preferred embodiment, said injection of water is made prior to the ignition point (ZZP) of a fuel/exhaust gas/air mixture in the respective combustion chamber. Such an injection of water can be made during a compression stroke, during an expansion stroke, or during an intake stroke. In principle, an injection of water is possible from the moment the exhaust valve closes up until the ignition point (ZZP). The set quantity of water can be introduced into the respective combustion chamber by means of a single or multiple injections. An injection of water during the intake stroke effects a uniform reduction in the temperature of the mixture. A late injection of water during the compression stroke on the other hand facilitates the formation of thermal stratification and the selective exploitation thereof. The decision to inject water during the intake or compression stroke must be made depending on the prevailing engine load and/or speed.

If a charge exchange strategy with residual gas retention is being employed, it is also conceivable that at least one injection of water could be made during an intermediate compression stage. This type of intermediate compression occurs when the exhaust and intake valves are closed before the entire volume of exhaust gas has been expelled, so that a part of the exhaust gas is retained in the combustion chamber as residual gas that is then intermediately compressed in the combustion chamber by the ascending piston.

An injection of water can be made immediately prior to the beginning of the controlled auto-ignition (RZV).

In a preferred embodiment, water is injected dependent on the pressure prevailing in the respective combustion chamber. It is also conceivable and advantageous to inject water dependent on the temperature prevailing in the respective combustion chamber.

Thus the temperature of the fuel/exhaust gas/air mixture can be controlled and adjusted by the injection of water into the combustion chamber, so that it is possible to implement the NAV partial operating mode at engine load ranges that would otherwise not be suitable without water injection due to the increased knocking tendency and reduced operation stability.

A directly injected internal combustion engine having a plurality of combustion chambers can be operated according to different operating modes or different partial operating modes. Hence there are a number of Otto-cycle partial operating modes possible. The stoichiometric Otto-cycle partial operating mode has a combustion air ratio or air/fuel ratio λ=1 and is spark ignited by an ignition device, whereby flame front combustion (FFV) sets in. The stoichiometric Otto-cycle partial operating mode can be applied throughout the entire engine load and/or engine speed range. It is preferentially implemented over other partial operating modes in the high engine load or engine speed range.

An Otto-cycle partial operating mode can be spark ignited even with excess air, and can thus be implemented with a combustion air ratio λ>1. This partial operating mode is also commonly referred to as the DES partial operating mode (Stratified Direct Injection), wherein a stratified, overall lean fuel/exhaust gas/air mixture is formed in the respective combustion chamber by multiple direct fuel injections. Due to its stratified composition, at least in an idealized system, each combustion chamber has two regions having different combustion air ratios λ. This stratification is typically generated through multiple fuel injections. First, a lean, homogeneous fuel/exhaust gas/air mixture may be introduced into the respective combustion chamber by one or more injections of fuel. Into this lean, homogeneous region, a fuel/air mixture that is richer than that in the lean, homogeneous region, is then positioned in the area of the ignition device by a final injection of fuel that can also take the form of multiple injections. This method is commonly referred to as HOS (Homogenous Stratified Mode). The overall lean fuel/exhaust gas/air mixture in the combustion chamber can be ignited and reacted through flame front combustion (FFV) by the richer fuel/air mixture in the area of the ignition device. The DES and HOS partial operating modes are preferred in the lower engine load and/or engine speed range.

The DES and HOS partial operating modes can also be compression ignited, but are then usually no longer referred to as DES or HOS partial operating modes.

At lower engine load and/or engine speed ranges, the RZV partial operating mode can likewise be implemented, wherein a lean, homogeneous fuel/exhaust gas/air mixture in the respective combustion chamber is triggered by controlled auto-ignition and thus compression ignited. In contrast with an Otto-cycle partial operating mode, wherein a flame front combustion (FFV) arises through spark ignition, with the RZV partial operating mode, the fuel/exhaust gas/air mixture in the respective combustion chamber ignites in multiple regions of the respective combustion chamber almost simultaneously so that controlled auto-ignition occurs. The RZV partial operating mode exhibits significantly lower NOx emissions compared to the Otto-cycle partial operating mode, while at the same time being characterized by lower fuel consumption.

The NAV partial operating mode, which is the subject matter of the invention, can be thought of as being a combination of a spark-ignited, Otto-cycle partial operating mode and an RZV partial operating mode. Thus, for the NAV partial operating mode there is a homogeneous, lean fuel/exhaust gas/air mixture that is spark ignited by means of an ignition device. With the NAV partial operating mode, following an initial flame front combustion (FFV), the combustion of the homogeneous fuel/exhaust gas/air mixture transitions to a controlled auto-ignition (RZV). As a result, the NAV partial operating mode exhibits lower fuel consumption and reduced NOx emissions when compared to the Otto-cycle partial operating mode due to the controlled auto-ignition (RZV).

In contrast with the RZV partial operating mode, during the NAV partial operating mode combustion is spark ignited by an ignition device. For this reason, amongst others, operating stability of the mixture ignition and/or combustion is significantly improved, especially in the higher end of the engine load or engine speed range. Thus the homogeneous, lean fuel/exhaust gas/air mixture starts to combust with a kind of a Otto-cycle flame front combustion (FFV) that then transitions into a controlled auto-ignition (RZV). In this way the NAV partial operating mode combines the advantages of controlled auto-ignition (RZV) with the spark-ignited, operationally stable ignition of the fuel/exhaust gas/air mixture. Implementation of the NAV partial operating mode that is the subject matter of the invention can thus be controlled by supplying an appropriate fuel/exhaust gas/air mixture to each combustion chamber, as well as by means of spark igniting at the correct time by means of an ignition device.

The NAV partial operating mode is characterized by a low pressure gradient and a reduced knocking tendency. As a result of this, the NAV partial operating mode makes controlled auto-ignition (RZV) feasible in a higher engine load range at which the pure RZV partial operating mode is no longer operationally stable enough due to the increasing pressure gradient and irregular combustion conditions, and in particular, because of the increased knocking tendency.

A comparison of the partial operating modes leads to the following conclusion:

| Partial operating | Fuel | NOₓ | | Engine |
|---|---|---|---|---|
| modes | consumption | emissions | Application | smoothness |
| Otto-cycle λ = 1 | +/− | +/− | +++ | +/− |
| DES | +++ | −− | + | +/− |
| RZV | ++ | +++ | + | +/− |
| NAV | ++ | ++ | ++ | ++ |

(− \hat{=} deterioration, + \hat{=} improvement, ++ \hat{=} much improvement, +++ \hat{=} very much improvement)

As a result, partial operating modes with controlled auto-ignition (RZV) exhibit both lower fuel consumption and reduced NOx emission values when compared with stoichiometric Otto-cycle combustion systems. Moreover, through the NAV partial operating mode, the operating range can be extended to include the efficient controlled auto-ignition mode. With the NAV combustion method, engine smoothness is also improved when compared to the partial operating modes with compression ignition.

A lean fuel/exhaust gas/air mixture is a fuel/exhaust gas/air mixture that has a combustion air ratio of λ>1 and thus an excess of air, whereas a rich fuellexhaust gas/air mixture has a combustion air ratio of at least λ=1.

The combustion air ratio is a dimensionless physical quantity that is used to describe the composition of a fuel/exhaust gas/air mixture. The combustion air ratio λ is calculated as a quotient of the actual air mass available for combustion and the minimum stoichiometric air mass required for a complete combustion of the available fuel. Accordingly, if λ=1, one talks of a stoichiometric combustion air ratio or fuellexhaust gas/air mixture, and when λ>1 of a lean air combustion ratio or fuel/exhaust gas/air mixture. Furthermore, if λ=1 or λ<1, one talks of a rich combustion air ratio or fuel/exhaust gas/air mixture.

In a preferred embodiment, there is for the NAV partial operating mode a combustion air ratio it at the ignition point (ZZP) between 1 and 2.

Furthermore, the composition of the fuel/exhaust gas/air mixture can be specified by the charge dilution. Regardless of whether there is a lean, rich or stoichiometric fuellexhaust gas/air mixture, the charge dilution dictates how much fuel in relation to the other components of the fuel/exhaust gas/air mixture was introduced into the combustion chamber. The charge dilution is the ratio of the mass of fuel to the total mass of the fuel/exhaust gas/air mixture that is present in the respective combustion chamber.

In a preferred embodiment of the NAV partial operating mode, the charge dilution is set to between 0.03 and 0.05.

Because ignition timing plays a crucial role in the NAV partial operating mode, in a preferred embodiment the ignition point is set to occur at a crank angle (CA) of between −45° and −10°.

The crank angle (CA) is the position in degrees of the crankshaft in relation to the movement of the piston in the cylinder or combustion chamber. In the case of a four-stroke cycle, where an intake stroke is followed by a compression stroke, then an expansion stroke and subsequently an exhaust stroke, the top dead center (TDC) position of the retracted piston in the respective combustion chamber or cylinder between the compression stroke and the expansion stroke is usually assigned a crank angle (CA) of 0°. Starting from this top dead center position at 0° CA, the crank angle increases in the direction of the expansion stroke and the exhaust stroke and decreases opposite to the direction of the compression stroke and intake stroke. Using the described gradation system, the intake stroke occurs between −360° CA and −180° CA, the compression stroke between −180° CA and 0° CA, the expansion stroke between 0° CA and 180° CA and the exhaust stroke between 180° CA and 360° CA.

When a largely homogeneous, lean fuel/exhaust gas/air mixture is referred to, this is understood to be a homogeneous, lean fuel/exhaust gas/air mixture that is essentially uniformly distributed in the respective combustion chamber. In an ideal situation there is a completely homogeneous distribution. In a realistic scenario, however, small inhomogeneities can be present, but they have no significant impact on the respective partial operating mode. This type of homogenous, lean fuel/exhaust gas/air mixture can be produced by single or multi-point fuel injection. In a preferred embodiment the injections or multi-point injections of fuel are performed dependent on load and/or engine speed.

In a preferred embodiment, the NAV partial operating mode is implemented at an engine speed of between 5% and 70% of the internal combustion engine's maximum speed.

In a likewise preferred embodiment, the NAV partial operating mode is implemented at an engine load of between 10% and 70% of the internal combustion engine's maximum load.

In addition, an internal exhaust gas recirculation can be effected as part of the NAV partial operating mode in order to preheat the fuel/exhaust gas/air mixture in the respective combustion chamber. This exhaust gas recirculation can be implemented as exhaust gas re-induction or exhaust gas retention. With exhaust gas re-Induction, exhaust gas is fed into the respective combustion chamber through expulsion of the exhaust gas into the air intake and/or into the exhaust section with subsequent re-induction. As an alternative to or in addition to exhaust gas re-induction, internal exhaust gas recirculation through the retention of exhaust gas can be implemented, wherein a portion of the exhaust gas is retained in the respective combustion chamber. In order to cool the fuel/exhaust gas/air mixture, external exhaust gas recirculation can be performed whereby the externally recirculated exhaust gas can be additionally cooled.

The NAV partial operating mode can be implemented in combination with, and/or in addition to a spark ignited, stratified DES partial operating mode.

In this case a preferred embodiment allows the ignition point (ZZP) and/or center of the combustion to be set at a crank angle that corresponds to the crank angle at the ignition point (ZZP) and/or the combustion centre of a spark ignited, stratified DES partial operating mode.

In this case a preferred embodiment involves the NAV partial operating mode being implemented at an engine speed range and/or engine load range at which a spark ignited, stratified DES partial operating mode is also possible.

In a particularly preferred embodiment, the NAV partial operating mode is implemented in combination with and/or in addition to an RZV partial operating mode with purely controlled auto-ignition (RZV), whereby the two partial operating modes are switched between if the other partial operating mode exhibits a lower operating stability.

Further important features and advantages of the invention arise from the sub-claims, from the diagrams and from the descriptions based on the diagrams.

The features mentioned above and others still to be described in the following description can be used not only in the combination specified in each case, but also in other combinations or individually, within the scope of the present invention.

Preferred exemplary embodiments of the invention are illustrated in the figures and explained in more detail in the description below with reference to the accompanying drawings.

### BRIEF DESCRIPTION OF THE DRAWINGS

FIG. 1 shows a graphical representation of a combustion curve of the NAV operating mode,

FIG. 2 shows a comparison of valve lift heights of an RZV, NAV, and DES operating mode,

FIG. 3 is a graphical representation of an engine characteristics map of the RZV and NAV operating modes, and

FIG. 4 represents setting conditions for the RZV and NAV operating mode.

### DESCRIPTION OF EXEMPLARY EMBODIMENTS

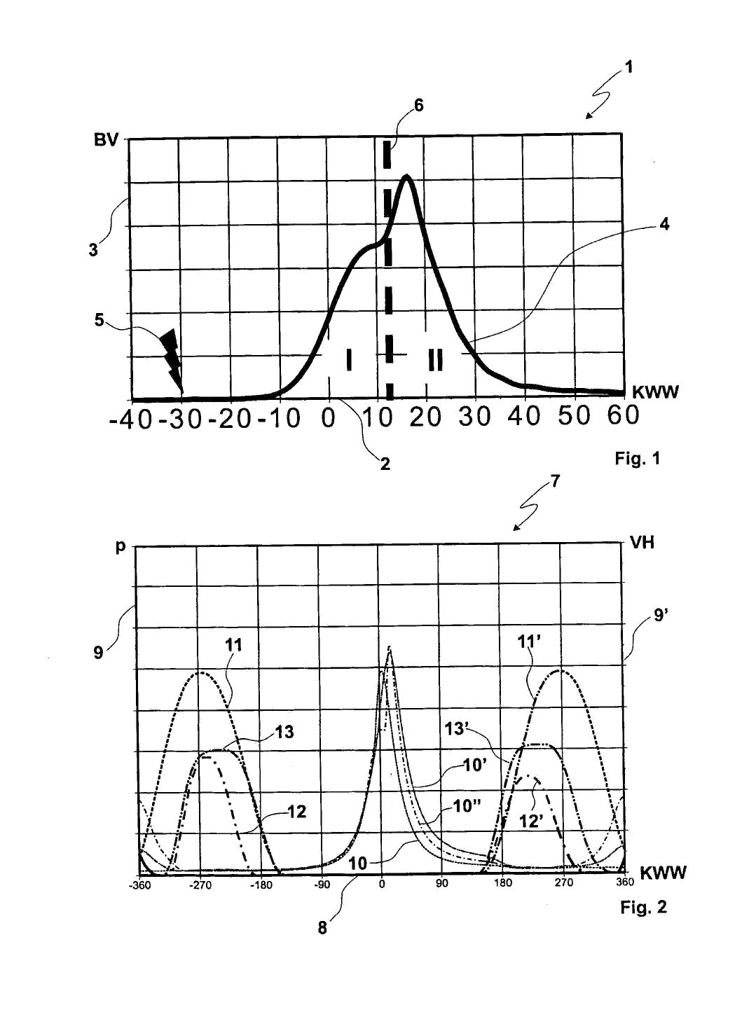

FIG. 1 shows a combustion curve diagram 1 of a NAV partial operating mode, where the crank angle CA is plotted along the X-axis 2 in degrees and where a combustion development is plotted up the Y-axis 3 in Joules. The combustion development of the NAV partial operating mode is represented by a curve 4. A fuel/exhaust gas/air mixture introduced into the respective combustion chamber is spark ignited at an ignition point 5 and at a crank angle of −30°+/−5° CA. Up to a boundary line 6 the fuel/exhaust gas/air mixture introduced into the respective combustion chamber burns with a Otto-cycle flame front combustion (FFV). From boundary line 6, the fuel/exhaust gas/air mixture, having become further heated and subjected to increased pressure by the flame front combustion (FFV), begins to transition to a controlled auto-ignition (RZV). A sufficiently high pressure and temperature required for controlled autoignition are built up by the advancing flame front combustion (FFV). In this way the NAV partial operating mode can be divided into a phase I having homogeneous flame front combustion (FFV) and a phase II having controlled auto-ignition (RZV), whereby both phases I, II are separated by the boundary line 6.

FIG. 2 shows a cylinder pressure/valve lift diagram 7, wherein the crank angle CA is plotted along the X-axis 8 in degrees and wherein the cylinder pressure P in bar and the valve lift VH in millimeters is plotted up the Y-axis 9,9′. The curves 10, 10′, 10″ reference the cylinder pressure curves of the DES, RZV and NAV partial operating modes respectively. The cylinder pressure gradation of the Y-axis 9 applies to these curves. Furthermore, the DES valve lift curves 11, 11′ the RZV valve lift curves 12,12′ and the NAV valve lift curves 13,13′ are plotted on the cylinder pressure/valve lift diagram 7. On comparing the valve lift curves 11, 11′, 12,12′, 13,13′ one notices that the NAV valve lift curves 13,13′ are considerably smaller than the DES valve lift curves 11,11′. The DES valve lift curves 11,11′ also span a larger range of crank angles than the NAV valve lift curves 13,13′. As a result, exhaust gas retention or an internal exhaust gas recirculation is hardly possible with this type of DES valve lift curve 11, 11′. In contrast to this, NAV valve lift curves such as this mean that an internal exhaust gas recirculation and/or an exhaust gas retention can be implemented.

If one now compares the RZV valve lift curves 12,12′ and the NAV valve lift curves 13,13′, one finds that the NAV valve lift curves 13,13′ exhibit a slightly greater valve lift and moreover, they span a wider range of crank angles than the RZV valve lift curves 12,12′. Consequently, such RZV valve lift curves 12, 12′ are characterized by a larger exhaust retention or internal exhaust gas recirculation, and allow as a result higher temperatures to be set in the combustion chamber. Due to the small amount of lift and short opening times, however, the air flow is greatly restricted. Consequently, such RZV valve lift curves 12, 12′ are of only limited use for a high engine load range. This is improved with the illustrated NAV valve lift curves 13, 13′, since on the one hand higher valve lifts can be set, and on the other the valve remains open through a wider range of crank angles. Thus using such NAV valve lift curves as 13, 13′ allows a lower temperature in the particular combustion chamber to be set, and the intake air volume is greater than with the RZV valve lift curves 12,12′ illustrated in FIG. 2.

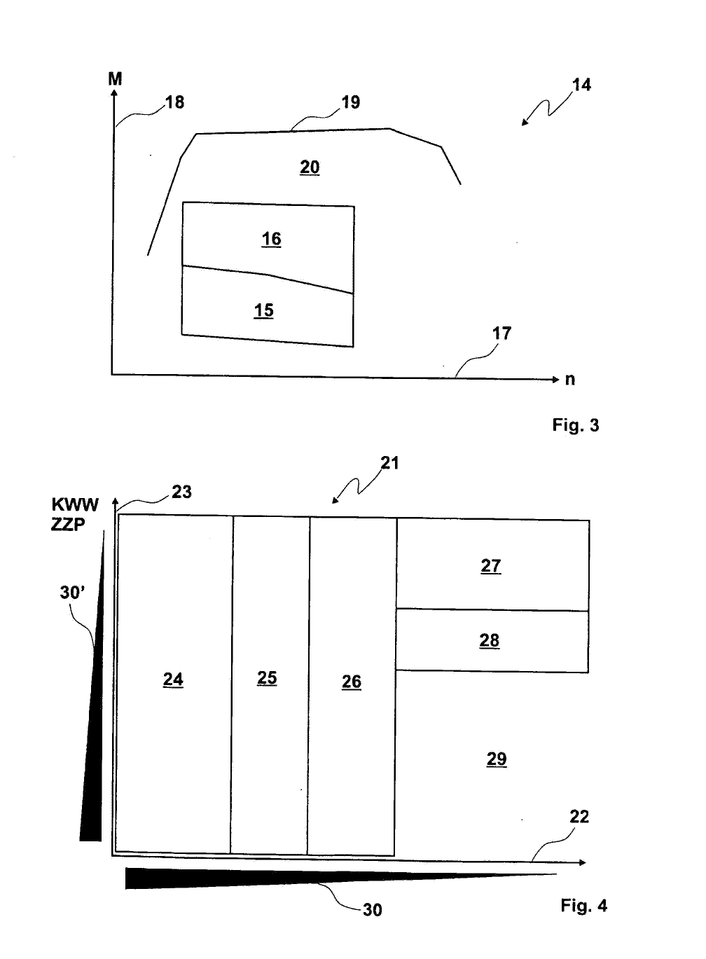

FIG. 3 shows an engine load/engine speed diagram 14, in which an engine characteristics map 15 for the RZV partial operating mode and an engine characteristics map 16 for the NAV partial operating mode are plotted. In the engine load/engine speed diagram 14, the engine speed is plotted along the X-axis 17 while the engine load is plotted up the Y-axis 18. A boundary curve 19 delimits the engine load and engine speed range within which the internal combustion engine can be operated. In the engine load/engine speed range 20, which is not encompassed by the engine characteristics map 15 of the RZV partial operating mode or by the engine characteristics map 16 of the NAV partial operating mode, an Otto-cycle partial operating mode can be implemented.

A setting conditions diagram 21 shown in FIG. 4 schematically illustrates setting conditions for the RZV partial operating mode and for the NAV partial operating mode. The charge dilution is plotted along an X-axis 22, that decreases in the direction of the X-axis 22 as illustrated by a tapered bar 30. Correspondingly, the engine load increases along the X-axis 22. The crank angle (CA) at the ignition point (ZZP) is plotted up a Y-axis 23, said crank angle likewise decreasing in the direction of Y-axis 23 as illustrated by a tapered bar 30. The operating ranges 24, 25, 26, 27, 28, 29 are mapped in the settings condition diagram 21. The operating range 24 indicates a possible operating range for the RZV partial operating mode. In this very high charge dilution range it is not possible to spark ignite the correspondingly dilute fuellexhaust gas/air mixture with an ignition device. The RZV partial operating mode can be advantageously implemented in said operating range 24. With decreasing charge dilution, both the RZV partial operating mode as well as the NAV partial operating mode can be advantageously implemented in the operating range 25. By using the NAV partial operating mode, the center of combustion can be shifted to occur at an earlier crank angle by means of the ignition timing.

If one further lowers the charge dilution, one enters the operating range 26. While it is possible to implement the RZV partial operating mode in operating range 26, in this charge dilution range, the RZV partial operating mode exhibits an increased knocking tendency and is characterized by a correspondingly large increase in pressure. For this reason, in this charge dilution range the RZV partial operating mode suffers from increased operating instability that can be mitigated for instance by an external exhaust gas recirculation. This operating range 26 can be bypassed by the NAV partial operating mode, whereby the center of combustion can in this case likewise be shifted to occur at a lower crank angle by an appropriate choice of ignition timing (ZZP).

The NAV partial operating mode is preferentially implemented in the operating range 27. An Otto-cycle partial operating mode can be implemented in the operating range 28. It is usually not possible to implement the RZV, NAV or DES partial operating modes in the operating range 29.

The compression ratio of the internal combustion engine must be advantageously calculated in order to further improve operation of the internal combustion engine. In particular, the NAV partial operating mode is implemented with a compression ratio ε of between 10 and 13.

The compression ratio ε is the quotient of the compression volume of the combustion chamber when the piston is at its top dead centre position and the sum of the compression volume and the displacement volume of the combustion chamber when the piston is at its bottom dead center position.

When switching from the RZV partial operating mode to the NAV partial operating mode, the compression ratio c is lowered. As a result of the lower compression ratio ε, the knocking tendency is significantly reduced, and an earlier centre of combustion, as well as a resultant increase in operational stability for the NAV partial operating mode, is effected.

When switching from the NAV partial operating mode to the RZV partial operating mode, the compression ratio ε is raised.

What is claimed is:

1. An operating method for a direct-injection gasoline internal combustion engine with exhaust gas recirculation, wherein a controlled autoignitlon (RZV) partial operating mode is implemented in a region of an engine characteristics map having low to medium speed or low to medium load, wherein in the RZV partial operating mode a lean fuellexhaust gas/air mixture is ignited by compression ignition and combusts by controlled auto-ignition (RZV), wherein a region of the engine characteristics map with compression ignition is bordered at higher load by another region of the engine characteristics map in which low NOₓ combustion (NAV) partial operating mode is performed, and wherein at an ignition point (ZZP) a homogeneous, lean fuellexhaust gas/air mixture with combustion air ratio λ>1 in a given combustion chamber of the internal combustion engine is spark ignited by means of an ignition device, a flame front combustion (FFV) initiated by the spark ignition transitions to controlled auto-ignition (RZV) is established in which, at least in the NAV partial operating mode, water is injected into a respective combustion chamber by at least one injection.

2. The operating method according to claim 1, wherein at least temporarily, the controlled auto-ignition (RZV) partial operating mode is supplanted by a DES partial operating mode, whereby the DES partial operating mode is implemented instead of the RZV partial operating mode.

3. The operating method according to claim 1, wherein water is injected into the combustion chamber during a compression stroke.

4. The operating method according to claim 1 wherein at least one injection of water is made around the ignition point (ZZP).

5. The operating method according to claim 1, wherein at least one injection of water is made during an expansion stroke.

6. The operating method according to claim 1, wherein at least one injection of water is made during an intake stroke.

7. The operating method according to claim 1, wherein at least one injection of water is made before controlled auto-ignition (RZV) is started.

8. The operating method according to claim 1, wherein, in the case of exhaust gas retention in the combustion chamber, at least one injection of water is made during an intermediate compression event.

9. The operating method according to claim 1, wherein at least one injection of water is made dependent on the pressure prevailing in a respective combustion chamber.

10. The operating method according to claim 1, wherein at least one injection of water is made dependent on the temperature prevailing in a respective combustion chamber.

11. The operating method according to claim 1, wherein, when switching from the RZV partial operating mode to the NAV partial operating mode, a compression ratio ε is lowered, and when switching from the NAV partial operating mode to the RZV partial operating mode, the compression ratio ε is raised.
